(19) United States
(12) Patent Application Publication
(10) Pub. No.: US 2008/0143471 A1
(43) Pub. Date: Jun. 19, 2008

(54) Fuse assembly

(76) Inventor: Chun-Chang Yen, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/639,208

(22) Filed: Dec. 15, 2006

(51) Int. Cl. H01H 85/04

(52) U.S. Cl. 337/231; 337/142

(57) ABSTRACT

The present invention relates to a fuse assembly, which includes a main body, two metal legs, a meltable rod having its both ends being connected by inner ends of the metal legs respectively, and a cover. A thin tin layer is connected tightly between the inner end of the metal leg and the rod without any space. The fuse assembly then obtains a perfect electrical connection. It cab be used on any electrical product with a high effective and stable function.

### FIELD OF THE INVENTION

The present invention relates to a fuse assembly, which provides an improved fuse structure to obtain a well connection between a meltable rod and inner connecting ends of metal legs.

### BACKGROUND OF THE INVENTION

A conventional fuse of normal electrical products, as shown in FIG. 1 and 2, includes a main body (1), two metal legs (2), a meltable rod (3), and a cover (4). The metal leg (2) has its short inner end (21) connect with the rod (3) and has its long outside end (22) joint with IC board. In order to connect the inner end (21) of the metal leg (2) with the rod (3) effectively, it is known that the inner end (21) is winded around the end of the rod (3), as shown in FIG. 3 and 5. Then, tin (5) is welded from outside face. After cooling, the inner end (21) and the meltable rod (3) are connected together, as in FIG. 4 and 6. But such connection is not well enough. From FIG. 7, it can be found that tin (5) is not fulfilled therebetween while space is existed. When the fuse is used, the electrical current will not be stable. Hence, it could be damaged more easily and the electrical product having this damaged fuse is also broken at all.

### SUMMARY OF THE INVENTION

The present invention is to provide an improved fuse assembly to overcome the drawback of prior art, which includes a perfect connection between inner ends of the metal legs and the meltable rod that promises stable electrical current and a safe function. Now, accompanying with the following drawings, the character of the present invention will be described here and after.

### BRIEF DESCRIPTION OF THE DRAWINGS

FIG. 1 is an exploded perspective view showing a conventional fuse structure.

FIG. 2 is an assembled view of FIG. 1.

FIG. 3 is a further exploded view of FIG. 1.

FIG. 4 is an assembled view of FIG. 3.

FIG. 5 is an enlarged plan view showing parts of FIG. 1.

FIG. 6 is an enlarged plan view showing parts of FIG. 4.

FIG. 7 is a cross-sectional plan view of FIG. 6.

FIG. 8 is an exploded perspective view showing a fuse assembly according to the present invention.

FIG. 9 is an assembled view of FIG. 8.

FIG. 10 is an enlarged plan view showing parts of FIG. 8.

FIG. 11 is an enlarged plan view showing parts of FIG. 9.

FIG. 12 is a cross-sectional plan view of FIG. 11.

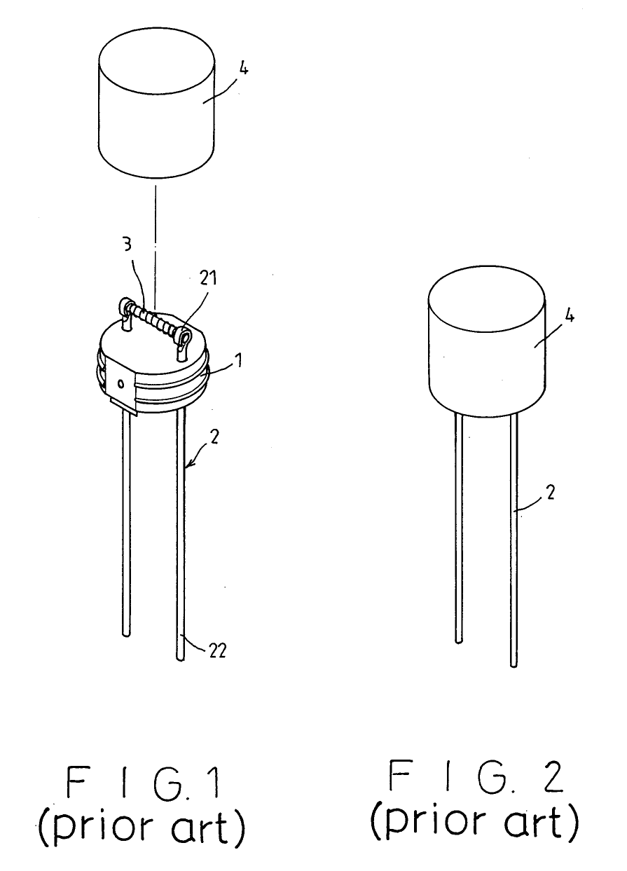

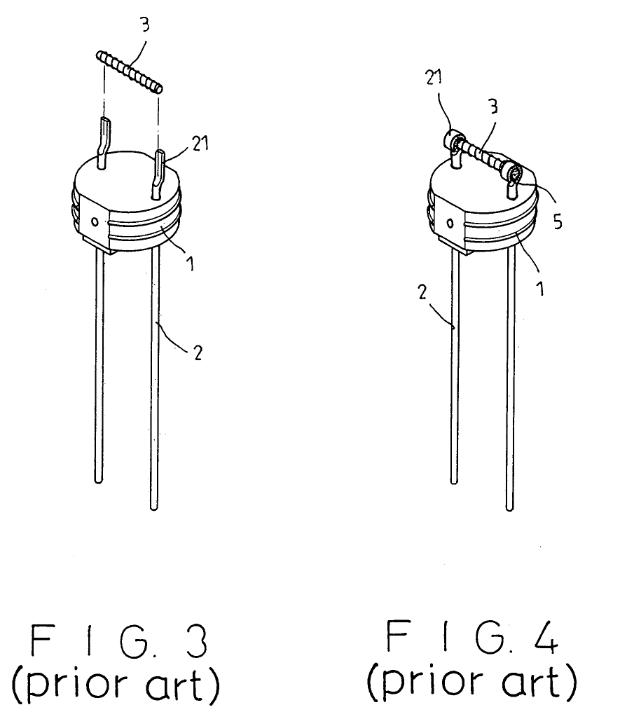

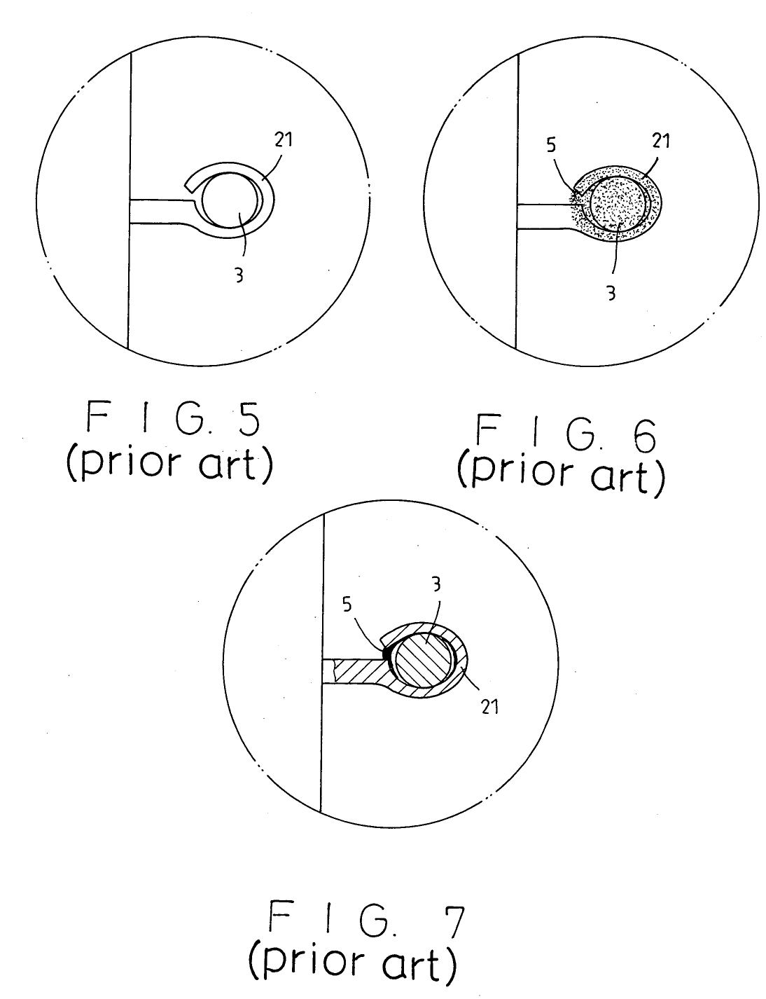

### DETAILED DESCRIPTION OF THE PREFERRED EMBODIMENT

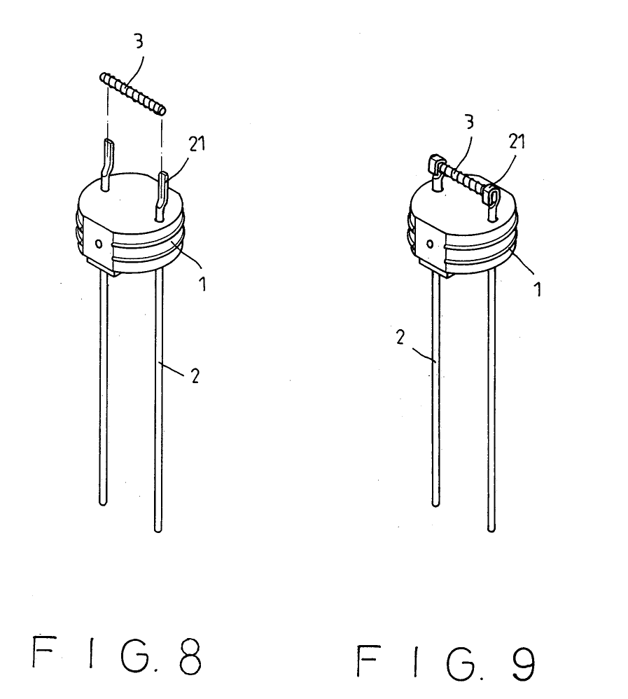

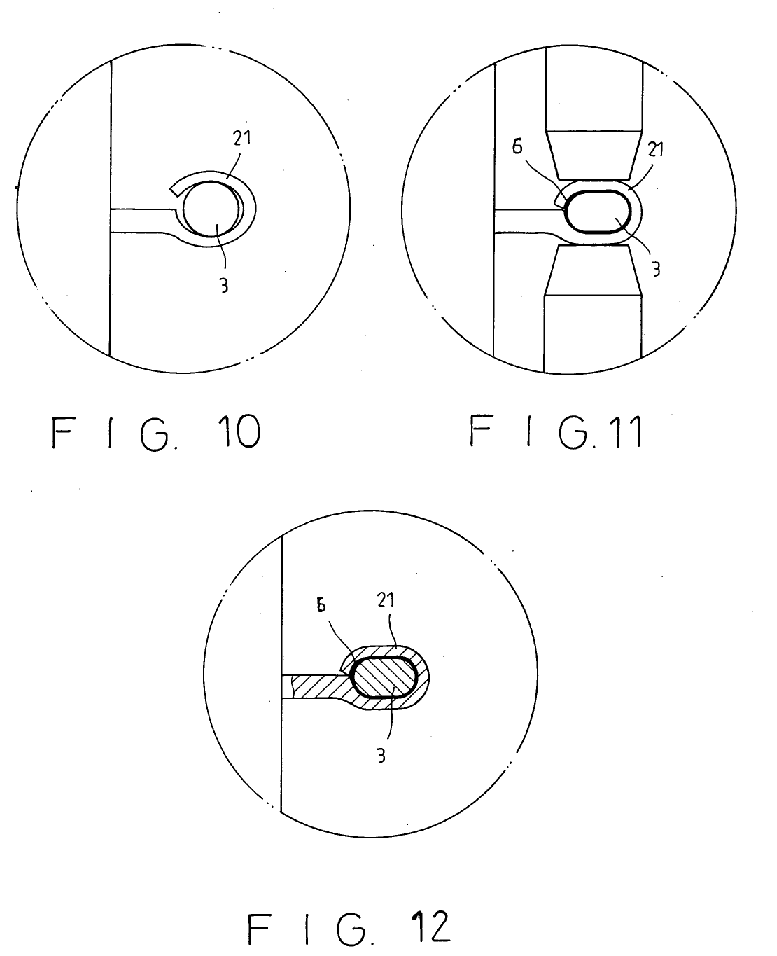

Referring to FIG. 8 to 12, the present invention relates to an improved fuse assembly, which includes a main body (1), two metal legs (2), and a meltable rod (3), which has its both ends being connected by inner ends (21) of the metal legs (2) respectively. The character of the present invention is in that a thin tin layer (6) is coated evenly between the inner end (21) and the rod (3) without any space.

When the inner end (21) is winded around the rod (3), a thin tin layer (6) has been coated in its inner face in advance. By use of an instance high temperature and pressure from both sides, such as shown in FIG. 11, tin layer (6) will be melted first and fulfilled between the inner end (21) and the rod (3). After cooling, the inner end (21) and the rod (3) can be connected together tightly and tin layer (6) is fulfilled therebetween without any space. It is to be understood that the fuse assembly obtains a perfect electrical connection. It cab be used on any electrical product with a high effective and stable function.

The above-mentioned structure is only an embodiment to illustrate my design and is not to limit the scope of this application. Any modified embodiment with similar merits will be still claimed by the present invention.

I claim:

1. A fuse assembly including a main body, two metal legs, a meltable rod, which has its both ends being connected by inner ends of the metal legs respectively, and a cover, and the character is in that a thin tin layer is connected tightly between the inner end of the metal leg and the rod without any space.
